(19) United States
(12) Patent Application Publication
(10) Pub. No.: US 2012/0004351 A1
(43) Pub. Date: Jan. 5, 2012

(54) Crosslinked Thermoplastic Polyurethane Elastomers

(76) Inventors: Chung-Yu Huang, Tainan (TW); Kuo-I Lee, Tainan (TW)

(21) Appl. No.: 12/827,352

(22) Filed: Jun. 30, 2010

(51) Int. Cl. C08L 75/04; C08K 3/04; C08K 3/34; C08L 1/02; C08K 3/22; C08G 18/71; C08K 5/3492

(52) U.S. Cl. 524/35; 528/75; 525/453; 524/590; 524/101; 524/430; 524/445; 977/742

(57) ABSTRACT

This disclosure is directed to crosslinked thermoplastic polyurethane elastomers that include allyl ether side groups in the urethane structure, specifically in the hard segments of the polyurethane polymer, and a free radical source. This disclosure is also directed to methods of synthesizing the crosslinked thermoplastic polyurethane elastomers having allyl ether side groups in the hard segments. The solvent resistance, water resistance, weather resistance, and heat resistance are improved as a result of the urethanes elastomers being prepared according to this disclosure. As a result of these improved properties, the finished crosslinked polyurethane elastomers can be applied in articles such as footwear parts or soles, tubes, hoses, cables, films and sheets.

### BACKGROUND

The present disclosure is directed to crosslinked thermoplastic polyurethane elastomers that include allyl ether side groups in the urethane structure and a radical source together in the system, and methods for preparation thereof. The solvent resistance, water resistance, weather resistance, and heat resistance are improved as a result of the urethanes elastomers being prepared according to this disclosure. As a result of these improved properties, the finished crosslinked polyurethane elastomers can be applied in articles such as footwear parts or soles, tubes, hoses, cables, films and sheets.

Continuous production of thermoplastic polyurethane elastomers through a reactive twin screw extruder is a common technology for those skilled in the art. Because the heat resistance and solvent resistance are not satisfactory in some applications, it has become an important issue to develop a new form of thermoplastic polyurethane elastomer to improve such heat and solvent resistance properties.

The process to make crosslinked or crosslinkable thermoplastic polyurethane elastomers is developed to fit the above property requirements. U.S. Pat. No. 6,258,310 describes a process for adding an isocyanate-rich prepolymer into the preformed thermoplastic polyurethane elastomers to make crosslinked thermoplastic polyurethane elastomers. Although this process is so-called “one step” forming crosslinked thermoplastic polyurethane elastomers in a single or twin screw extruder, it is still too complicated for melting preformed thermoplastic polyurethane elastomers before adding the thermoplastic polyurethane elastomers into the twin screw extruder.

Another process to prepare crosslinked thermoplastic polyurethane elastomers with acrylate side groups has been disclosed in U.S. Pat. Nos. 4,334,034, 4,366,301 and 4,367,302. Because at least one secondary hydroxyl group is involved in the acrylate diol, which is a chain extender with low reactivity in polyurethane preparation, in addition to the high reactivity of the radical-mediated unsaturated bonds, the dominated radical reaction will produce polymer chains too short or too branched as both kinds of reactions happen simultaneously. This will result in thermoplastic polyurethane elastomers with poor mechanical properties, so their applications are limited in the continuous single or twin-screw extruder manufacture.

To improve the aforementioned drawbacks, instead of the acrylate diol, this present disclosure applies an allyl ether diol with at least two primary hydroxyl groups at sides to control the reaction in an easier way. This will result in forming a high degree of thermoplastic polyurethane elastomer followed by a crosslinking through radical-mediated unsaturated bonds of allyl ether diols. Therefore, an easily controlled “one step” continuous process for preparing crosslinked thermoplastic polyurethane elastomers is developed.

### SUMMARY

In one aspect, this disclosure provides crosslinked thermoplastic polyurethane elastomers, with allyl ether side groups, derived from reacting an organic isocyanate with a mixture of:
(a) an unsaturated diol comprises two primary hydroxyl groups and at least one allyl ether group at the side having the formula:

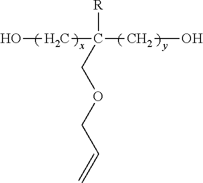

in which R is alkyl group with or without modified functional groups, and x and y are integers of 1 to 4;
(b) a chain extender, possessing at least two reaction sites with isocyantes, having a molecular weight less than 450;
(c) a long chain polyol having a molecular weight between 500 and 4,000;
(d) a radical initiator which can generate free radicals, generally selected from the group consisting of peroxides, sulfurs, and re-dox systems;

wherein the NCO index (i.e. the ratio of isocyanate to active hydrogen containing groups) is from 0.9 to 1.3; and wherein from 0.1% to 25% of the weight of unsaturated diols is comprised in the finished thermoplastic polyurethane elastomers with the weight ratio of initiators to unsaturated diols of 0.001 to 1.

Moreover, this invention further comprises a process for forming the crosslinked thermoplastic polyurethane elastomers product described above using a single-screw, twin-screw, or a batch method to mix and react with all the ingredients.

Other systems, methods, features and advantages of the invention will be, or will become, apparent to one of ordinary skill in the art upon examination of the following figures and detailed description. It is intended that all such additional systems, methods, features and advantages be included within this description and this summary, be within the scope of the invention, and be protected by the following claims.

### DETAILED DESCRIPTION

This present disclosure provides a crosslinked thermoplastic polyurethane elastomer having unsaturated bonds in hard segments, where the unsaturated bonds in hard segments have unsaturated diols as chain extenders.

The organic isocyanates used for the production of crosslinked thermoplastic polyurethane elastomers of this invention may include any of the known aromatic, aliphatic, and cycloaliphatic di- or polyisocyanates. Examples of suitable isocyanates include: 2,2′-, 2,4′- and particularly 4,4-diphenylmethane diisocyanate and isomeric mixtures thereof; polyphenylene polymethylene polyisocyanates (poly-MDI, PMDI); 2,4- and 2,6-toluene diisocyanates and isomeric mixtures thereof, particularly an 80:20 mixture of the 2,4- and 2,6-isomers; the saturated, isophorone diisocyanate; 1,4-diisocyanatobutane; 1,5-diisocyanatopentane; 1,6-diisocyanatohexane; 1,4-cyclohexane diisocyanate; cycloaliphatic analogs of PMDI; and the like.

The crosslinked thermoplastic polyurethanes, with allyl ether side groups, may be derived from reacting an organic isocyanate with a mixture of:
(a) an unsaturated diol comprises two primary hydroxyl groups and at least one allyl ether group at the side having the formula:

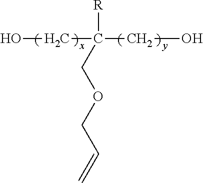

in which R is alkyl group with or without modified functional groups, and x and y are integers of 1 to 4;
(b) a chain extender, possessing at least two reaction sites with isocyantes, having a molecular weight less than 450;
(c) a long chain polyol having a molecular weight between 500 and 4,000;
(d) a radical initiator which can generate free radicals, generally selected from the group consisting of peroxides, sulfurs, and re-dox systems;

wherein the NCO index (i.e. the ratio of isocyanate to active hydrogen containing groups) is from 0.9 to 1.3; and wherein from 0.1% to 25% of the weight of unsaturated diols is comprised in the finished thermoplastic polyurethane elastomers with the weight ratio of initiators to unsaturated diols of 0.001 to 1.

Suitable chain extenders used in preparing thermoplastic polyurethane elastomers in this present disclosure include the common diols such as ethylene glycol, diethylene glycol, triethylene glycol, propylene glycol, dipropylene glycol, tripropylene glycol, 1,3-propanediol, 1,4-butanediol, 1,6-hexanediol, 1,10-decanediol, neopentyl glycol, dihydroxyethoxy hydroquinone, 1,4-cyclo-hexanedimethanol, 1,4-dihydroxycyclohexane, and the like. Minor amounts of crosslinking agents such as glycerine, trimethylolpropane, diethanolamine, and triethanolamine may be used in conjunction with the diol chain extenders.

In addition to the common diol chain extenders, diamines and amino alcohols may also be used in the practice of this present disclosure. Examples of suitable diamines are aliphatic, cyclolaliphatic or aromatic diamines, such as ethylene diamine, hexamethylene diamine, 1,4-cyclohexyene diamine, benzidine, toluene diamine, diaminodiphenyl methane, the isomers of phenylene diamine or hydrazine, and particularly substituted aromatic amines, such as MOCA (4,4′-methylene-bis-o-chloroaniline), M-CDEA (4,4′-methylenebis(3-chloro-2-6-diethyl-laniline)). Examples of suitable amino alcohols are ethanol amine, N-methylethanolamine, N-butylethanolamine, N-oleyethanolamine, N-cyclohexylisopropanolamine, and the like. Mixtures of various types of chain extenders may also be used in this invention.

Examples of suitable long chain polyols that may be used to form the polyurethane include polyhydroxy compounds having a molecular weight between 500 and 4,000, which may be selected from the group consisting of linear polyesters, polyethers, polycarbonates, polylactones (e.g. c-caprolactone), and mixtures thereof. In addition to the hydroxyl terminal groups, carboxyl, amino or mercapto groups can also be used as the terminal groups of the polyols in this invention.

Polyesters polyols are produced by the reaction of dicarboxylic acids and diols or esterifiable derivative thereof. Examples of suitable dicarboxylic acids include succinic acid, glutaric acid, adipic acid, suberic acid, azelaic acid, sebacic acid, decanedicarboxylic acid, maleic acid, fumaric acid, phthalic acid, isophthalic acid, and terephthalic acid. Examples of suitable diols include ethanediol, diethylene glycol, 1,2- and 1,3-propanediol, dipropylene glycol, 1,4-butanediol, 1,5-pentanediol, 1,6-hexanediol, 1,10-decanediol, glycerine and trimethylolpropanes, tripropylene glycol, tetraethylene glycol, tetrapropylene glycol, tetramethylene glycol, 1,4-cyclohexane-dimethanol, and the like. Both of the dicarboxylic acids and diols can be used individually or in mixtures to make specific polyesters in the practice applications.

Polyether polyols are prepared by the ring-opening addition polymerization of an alkylene oxide with an initiator of a polyhydric alcohol. Examples of suitable polyether polyols are polypropylene glycol (PPG), polyethylene glycol (PEG), polytetramethylene ether glycol (PTMEG). Block copolymers such as combinations of polyoxypropylene and polyoxyethylene glycols, poly-1,2-oxybutylene and polyoxyethylene glycols, poly-1,4-tetramethylene and polyoxyethylene glycols are also preferred in this invention.

Polycarbonate polyols are made through a condensation reaction of diols with phosgene, chloroformic acid ester, dialkyl carbonate or diallyl carbonate. Examples of diols in the suitable polycarbonate polyols of the polyurethane elastomers are ethanediol, diethylene glycol, 1,3-butanediol, 1,4-butanediol, 1,6-hexanediol, neopentylglycol, and 1,5-pentanediol.

The crosslinked thermoplastic polyurethane elastomers of this present disclosure comprise a sufficient degree of free radical initiator so as to be capable of inducing crosslinking structures in the hard segments by free radical initiation. The free radical initiator can generate free radicals through thermo cleavage or UV radiation. When the half-life and operation temperature of the free radical initiator are considered in the process, the weight ratio of initiators to unsaturated diols may be from 0.001 to 1. A variety of radical initiators may be used as the radical sources to make thermoplastic polyurethane elastomers having a crosslinking structure. Suitable radical initiators applied in this invention are peroxides, sulfurs, and sulfides, and peroxides may be used in particular embodiments. Peroxides such as aliphatic peroxides, and aromatic peroxides, such as diacetylperoxide, di-tert-butypperoxide, dicumyl peroxide, dibenzoylperoxide, 2,5-dimethyl-2,5-di(benzoylperoxy)hexane, 2,5-dimethyl-2,5-di(butylperoxy)-3-hexyne, 2,5-bis-(t-butylperoxy)-2,5-dimethyl hexane, n-butyl-4,4-bis(t-butylperoxyl)valerate, 1,4-bis-(t-butylperoxyisopropyl)-benzene, t-butyl peroxybenzoate, 1,1-bis-(t-butylperoxy)-3,3,5 tri-methylcyclohexane, and di(2,4-dichloro-benzoyl) can be applied in this disclosure.

Optionally, additional fillers and/or additives may be involved in the components of this disclosure based on the final desired characteristics such as enhancement of physical properties, UV light resistance, and other properties. To improve the UV light resistance, the components may include at least one light stabilizer, such as hindered amines, UV stabilizers, or a mixture thereof. Inorganic or organic fillers may also be added to the components of this invention. Suitable inorganic fillers include, but are not limited to, silicate minerals, metal oxides, metal salts, clays, metal silicates, glass fibers, natural fibrous minerals, synthetic fibrous minerals or mixtures thereof. Suitable organic fillers include, but are not limited to, carbon black, fullerene and/or carbon nanotubes, melamine colophony, cellulose fibers, polyamide fibers, polyacrylonitrile fibers, polyurethane fibers, polyester fibers based on aromatic and/aliphatic dicarboxylic acid esters, carbon fibers or mixtures thereof. The inorganic and organic fillers may be used individually or as a mixture thereof, and the total amount of the filler is preferably from 0.5 to 30 percent by weight of the polyurethane components.

Flame retardants may be used to improve the flame resistance of the thermoplastic polyurethane elastomers of this disclosure. Suitable flame retardants include organic phosphates, metal phosphates, metal polyphosphates, metal oxides (such as aluminum oxide hydrate, antimony trioxide, arsenic oxide), metal salts (such as calcium sulfate, expandable graphite), and cyanuric acid derivatives (such as melamine cyanurate). These flame retardants may be used individually or as a mixture thereof and the total amount of the flame retardant is preferably from 10 to 35 percent by weight of the polyurethane components.

To improve toughness and compression rebound, the thermoplastic polyurethane elastomers of this disclosure may include at least one dispersant, such as monomer or oligomer comprising unsaturated bonds. Examples of suitable monomers include styrene, acrylic esters; suitable oligomers include di- and tri-acrylates/methacrylates, ester acrylates/methacrylates, urethane or urea acrylates/methacrylates.

As described above, the suitable NCO index is from 0.9 to 1.3 in this disclosure. Also, the one step reaction to form the crosslinked polyurethane elastomers may be carried out in the single screw, twin screw, or the batch method. The products of the process may be in the form of pallets or grounded chips, and the products may be applied to form footwear parts or soles, tubes, hoses, and cables through the injection or extrusion machine directly to improve the heat resistance of the thermoplastic polyurethane elastomers.

The dwell times of the molten reaction mixture in the screw extruder are generally in the range of from 0.3 to 10 minutes, or from 0.4 to 4 minutes in some embodiments. The temperature of the screw housing is in the range of about 70 degrees Celsius to 280 degrees Celsius. The melt leaving the extruder is chilled and broken down into small pieces for the following injection or extrusion applications. For the batch method, all components are molten and mixed together with a high agitated stir at a temperature in the range of about 70 degrees Celsius to 120 degrees Celsius for 1 to 3 minutes, and then followed by a post curing process at a temperature in the range of about 70 degrees Celsius to 150 degrees Celsius for about 5 to 18 hours. The products made by this batch method will be ground to be in the form of chips for the injection or extrusion applications.

### EXAMPLES

The following examples will illustrate this invention in further detail. It is to be fully understood that these examples are provided for illustrative purposes only, and are not intended to limit the scope of the invention.

The parts and percentages referred to in the examples are parts by weight (pbw) or percentages by weight. All samples are prepared by mixing all components in a high agitated stir for 1 minute, starting at a temperature of about 70 degrees Celsius, followed by a 10-hour post curing process at a temperature of about 100 degrees Celsius. The post cured thermoplastic polyurethane elastomers are ground into small chips and a temperature of good flow is measured by a melt flow indexer (GT-7100-MIB, GOTECH) under a load of 5 kilograms. The materials used in the examples are as follows:

MDI=diphenylmethane diisocyanate (commercially available from Huntsman, under the trade name of Suprasec® 1100)

PTMEG=polytetramethylene ether glycol, having a number average molecular weight of 2,000. (commercially available from Invista, under the trade name of Terathane® 2000)

BG=1,4-butanediol (commercially available from BASF)

TMPME=trimethylolpropane monoallylether (commercially available from Perstorp Specialty Chemicals AB)

DCP=dicumyl peroxide (commercially available from LaPorte Chemicals Ltd.)

### Examples 1, 2 and Comparative Examples 3, 4

All components and the test results of Examples 1, 2, and Comparative Examples 3, 4 are shown in Table 1. As the temperature of good flow is corresponded to the property of heat resistance of a material, it is obviously that when 10% of TMPME are induced in the components, the additional peroxide (DCP) in Examples 1 and 2 will improve the heat resistance of the polyurethane elastomers with 35 to 40 degrees Celsius higher than that without peroxide (DCP), Example 4.

TABLE 1

| | | | Comparative | |
|---|---|---|---|---|
| | Examples | | Examples | |
| Example No. | 1 | 2 | 3 | 4 |
| PTMEG, pbw | 100 | 100 | 100 | 100 |
| BG, pbw | 15 | 15 | 15 | 15 |
| TMPME, % to total components | 10% | 10% | 0 | 10% |
| DCP, % to total components | 0.2% | 0.5% | 0 | 0 |
| MDI, pbw | 87.8 | 87.8 | 55.0 | 87.8 |
| NCO/OH | 1.01 | 1.01 | 1.01 | 1.01 |
| Temperature of good flow | 245° C. | 250° C. | 225° C. | 210° C. |
| ° C. in 5 kg force load) | | | | |

While various embodiments of the invention have been described, the description is intended to be exemplary, rather than limiting and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

What is claimed is:

1. A crosslinked thermoplastic polyurethane elastomer comprising unsaturated bonds in hard segments.

2. The crosslinked thermoplastic polyurethane elastomer of claim 1, wherein the unsaturated bonds in hard segments comprise unsaturated diols as chain extenders.

3. The crosslinked thermoplastic polyurethane elastomer of claim 1, wherein said crosslinked thermoplastic polyurethane elastomer is with allyl ether side groups, and is derived from reacting an organic isocyanate with a mixture of:
(a) an unsaturated diol comprises two primary hydroxyl groups and at least one allyl ether group at the side having the formula: 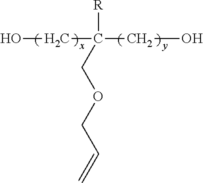
in which R is alkyl group with or without modified functional groups, and x and y are integers of 1 to 4;
(b) a chain extender, possessing at least two reaction sites with isocyantes, having a molecular weight less than 450;
(c) a long chain polyol having a molecular weight between 500 and 4,000;
(d) a sufficient degree of free radical initiator, which can generate free radicals capable of inducing crosslinking structures in said hard segments by free radical initiation, which is selected from the group consisting of peroxides, sulfurs, and sulfides.

4. The crosslinked thermoplastic polyurethane elastomer of claim 2, wherein the ratio of said crosslinked thermoplastic polyurethane elastomer to said unsaturated diols is from 100:0.1 to 100:25.

5. The crosslinked thermoplastic polyurethane elastomer of claim 1, wherein said crosslinked thermoplastic polyurethane elastomer comprises a sufficient degree of free radical initiator capable of inducing crosslinking structures in said hard segments by free radical initiation.

6. The crosslinked thermoplastic polyurethane elastomer of claim 5, wherein said free radical initiator is selected from the group consisting of peroxides, sulfurs, and re-dox systems.

7. The crosslinked thermoplastic polyurethane elastomer of claim 6, wherein said free radical initiator generates free radicals through a process selected from the group consisting of thermo cleavage and UV radiation.

8. The crosslinked thermoplastic polyurethane elastomer of claim 2, wherein said crosslinked thermoplastic polyurethane elastomer comprises a sufficient degree of free radical initiator capable of inducing crosslinking structures in said hard segments by free radical initiation.

9. The crosslinked thermoplastic polyurethane elastomer of claim 8, wherein the ratio of said free radical initiator to said unsaturated diols is from 0.001 to 1.

10. The crosslinked thermoplastic polyurethane elastomer of claim 3, further comprising at least one dispersant.

11. The crosslinked thermoplastic polyurethane elastomer of claim 10, wherein said dispersant is the monomer or oligomer comprising unsaturated bonds.

12. The crosslinked thermoplastic polyurethane elastomer of claim 3, further comprising at least one organic or inorganic filler component.

13. The crosslinked thermoplastic polyurethane elastomer of claim 12, wherein said organic filler component comprises carbon black, fullerene and/or carbon nanotubes, melamine colophony, cellulose fibers, polyamide fibers, polyacrylonitrile fibers, polyurethane fibers, polyester fibers based on aromatic and/aliphatic dicarboxylic acid esters, carbon fibers or a mixture thereof.

14. The crosslinked thermoplastic polyurethane elastomer of claim 12, wherein said inorganic filler component comprises silicate minerals, metal oxides, metal salts, clays, metal silicates, glass fibers, natural fibrous minerals, synthetic fibrous minerals or a mixture thereof.

15. The crosslinked thermoplastic polyurethane elastomer of claim 3, further comprising at least one light stabilizer.

16. The crosslinked thermoplastic polyurethane elastomer of claim 15, wherein said light stabilizer is hindered amines, UV stabilizer, or a mixture thereof.
